(19) United States
(12) Patent Application Publication
(10) Pub. No.: US 2018/0060839 A1
(43) Pub. Date: Mar. 1, 2018

(54) SYSTEMS AND METHODS FOR PREDICTING CHARGEBACK STAGES

(71) Applicant: MasterCard International Incorporated, Purchase, NY (US)

(72) Inventor: Ashwath Murali, Chesterfield, MO (US)

(21) Appl. No.: 15/246,647

(22) Filed: Aug. 25, 2016

(51) Int. Cl. G06Q 20/10; G06Q 40/02; G06F 17/30; G06N 5/04; G06N 7/00

(52) U.S. Cl. CPC G06Q 20/102; G06Q 40/02; G06N 7/005; G06N 5/04; G06F 17/30598

(57) ABSTRACT

A chargeback prediction computing device for predicting a chargeback stage for a payment transaction is provided. The chargeback prediction computing device is configured to store chargeback data from a plurality of chargebacks associated with a plurality of account holders wherein the chargeback data includes a plurality of variables, determine a set of indicators from the plurality of variables wherein the indicators include variables associated with each chargeback stage, generate a chargeback prediction model based on the set of indicators, receive candidate chargeback data for a candidate chargeback request wherein the candidate chargeback data includes a plurality of candidate variables, apply the chargeback prediction model to the candidate chargeback data to generate an output, and generate a chargeback type for the candidate chargeback request based on the output, wherein the chargeback type indicates a probability that the candidate chargeback request will reach a particular chargeback stage.

### BACKGROUND

The present application relates generally to payment account networks and, more particularly, to network-based systems and methods for determining a probability that a chargeback dispute will reach a presentment stage, a re-presentment stage, or an arbitration stage.

When a user of an account, such as an account associated with a payment card (e.g., such as a credit, debit or prepaid card), authorizes a transaction to purchase goods or services from a merchant using the account, an acquiring bank (i.e., the merchant bank) reimburses the merchant for the transaction. The acquiring bank then settles those funds with an issuing bank of the account corresponding to the payment card by presenting the transaction data into a transaction payment network. In a process known as clearing, transaction data is moved from the acquiring bank to the payment network, and from the payment network to the issuing bank. After clearing, settlement of the final payment occurs. Settlement is a process used to exchange funds between the acquiring bank and the issuing bank for the net value of a batch of all monetary transactions that have cleared for that processing day.

On occasion, the user may be unsatisfied with the goods or services provided by the merchant, may not recognize the purchase, may determine the purchase is fraudulent, or may otherwise dispute the transaction. In these examples, the user may request a chargeback from the issuing bank. The chargeback may be used to return the funds to the account corresponding to the payment card. Typically, the issuing bank immediately issues a credit to the account for the amount of the transaction. The issuing bank then sends a chargeback request to an issuing bank processor, and the request is collected with other requests and submitted in a batch to the payment network. However, the merchant may likewise dispute the chargeback with the assistance of the acquiring bank. The issuing bank and the acquiring bank may then attempt to mediate the charge through an arbitration proceeding. Depending on the outcome, the user, the issuing bank, the acquiring bank, or the merchant may be left with the cost of the transaction.

Accordingly, in an effort to conserve time and resources, it is beneficial for an issuer bank to be able to determine whether a chargeback dispute will reach a presentment stage, a re-presentment stage, or an arbitration stage.

### BRIEF DESCRIPTION OF THE DISCLOSURE

In one aspect, a method for predicting a chargeback stage for a payment transaction is provided. The method is implemented by a chargeback prediction computing device in communication with a memory. The method includes receiving chargeback data from a plurality of chargebacks associated with a plurality of account holders wherein the chargeback data includes a plurality of variables, determining a set of indicators from the plurality of variables wherein the indicators are variables associated with each chargeback stage, generating a chargeback prediction model based on the set of indicators, receiving candidate chargeback data for a candidate chargeback request wherein the candidate chargeback data includes a plurality of candidate variables, applying the chargeback prediction model to the candidate chargeback data to generate an output, and generating a chargeback type for the candidate chargeback request based on the output from the chargeback prediction model and the candidate chargeback data, wherein the chargeback type indicates a probability that the candidate chargeback request will reach a particular chargeback stage.

In another aspect, a chargeback prediction computing device for predicting a chargeback stage for a payment transaction is provided. The chargeback prediction computing device is in communication with a memory. The chargeback prediction computing device is configured to store chargeback data from a plurality of chargebacks associated with a plurality of account holders wherein the chargeback data includes a plurality of variables, determine a set of indicators from the plurality of variables wherein the indicators include variables associated with each chargeback stage, generate a chargeback prediction model based on the set of indicators, receive candidate chargeback data for a candidate chargeback request wherein the candidate chargeback data includes a plurality of candidate variables, apply the chargeback prediction model to the candidate chargeback data to generate an output, and generate a chargeback type for the candidate chargeback request based on the output from the chargeback prediction model and the candidate chargeback data, wherein the chargeback type indicates a probability that the candidate chargeback request will reach a particular chargeback stage.

In another aspect, a non-transitory computer-readable storage medium having computer-executable instructions embodied thereon is provided. When executed by a chargeback prediction computing device having at least one processor coupled to a memory, the computer-executable instructions cause the chargeback prediction computing device to store chargeback data from a plurality of chargebacks associated with a plurality of account holders wherein the chargeback data includes a plurality of variables, determine a set of indicators from the plurality of variables wherein the indicators include variables associated with each chargeback stage, generate a chargeback prediction model based at least in part on the set of indicators, receive candidate chargeback data for a candidate chargeback request wherein the candidate chargeback data includes a plurality of candidate variables, apply the chargeback prediction model to the candidate chargeback data to generate an output, and generate a chargeback type for the candidate chargeback request based on the output from the chargeback prediction model and the candidate chargeback data, wherein the chargeback type indicates a probability that the candidate chargeback request will reach a particular chargeback stage.

### BRIEF DESCRIPTION OF THE DRAWINGS

FIG. 1 is a schematic diagram illustrating an exemplary multi-party payment processing system for processing payment card transactions.

FIG. 2 is a data flow diagram illustrating an example generation of a chargeback prediction model and a chargeback type in accordance with the present disclosure.

FIG. 3 an example configuration of a chargeback prediction (CP) computing device used to generate the chargeback prediction model and the chargeback type, as shown in FIG. 2.

FIG. 4 is a block diagram depicting an example embodiment of the CP computing device, as shown in FIG. 3.

FIG. 5 is a data flow block diagram illustrating an example of the CP computing device generating the chargeback prediction model and the chargeback type, as shown in FIGS. 3 and 4.

### DETAILED DESCRIPTION OF THE DISCLOSURE

When a transaction occurs that is associated with a payment card (i.e., an account having a primary account number (PAN) associated therewith), a cardholder of the account has a period of time, for example, 120 to 180 days, during which the cardholder can dispute the transaction with an issuing bank. A chargeback occurs when the cardholder of the account contacts the issuing bank to inform the issuing bank that the cardholder would like the charge removed from the account and funds from the transaction returned to the account. A few potential examples for granting chargebacks may include an incorrect transaction amount, duplicate billing, a previously canceled recurring payment being charged, services not being rendered, credit not being processed, and fraudulent transactions.

There are typically three stages to the chargeback process. The first stage is presentment, in which a merchant processes a transaction made with a payment card and the transaction at some point results in a chargeback request made by a cardholder to an issuing bank. The issuing bank then determines whether to initiate a chargeback against an account of the merchant with an acquiring bank through a payment network.

The second stage, re-presentment, occurs when the acquiring bank and/or the merchant reject the chargeback and provide additional proof or documentation to the issuing bank that the disputed transaction was valid, such as, for example, a signed receipt or proof of delivery.

The third stage, arbitration, occurs when the re-presentment is rejected by the issuing bank. When arbitration occurs, a case filing is generated with the payment network. When presented with the case filing, the payment network reviews the disputed transaction and issues a financial liability decision regarding the chargeback.

Described herein is a chargeback prediction (CP) computing device, system, and method for generating a chargeback prediction model that determines the probability that a chargeback dispute will reach the presentment stage, the re-presentment stage, or the arbitration stage. This information assists users (e.g., issuing banks) in determining the probability that a transaction already submitted for a chargeback will reach a given chargeback stage. The CP computing device includes at least one processor in communication with a memory. The CP computing device is further in communication with or is a part of a payment card processing network such as, for example, an interchange network or a clearinghouse network. The CP computing device generates the chargeback prediction model based on data retrieved from a data warehouse (i.e., a chargeback database, a clearinghouse database, etc.).

The data warehouse contains chargeback data from a plurality of chargebacks requested by account holders. The chargeback data includes, but is not limited to, one or more of the following for the chargebacks: an acquiring bank identifier, an issuing bank identifier, an original transaction amount, a chargeback amount, a chargeback date, an acquiring bank reference number, a chargeback identifier, a chargeback reason code, a merchant name, a merchant country, a merchant state, merchant city, merchant location ID, transaction currency, card product type, merchant category code, e-commerce indicator, contactless payment indicator, recurring transaction indicator, account holder presence indicator, cross border indicator, whether a chargeback reached the presentment stage, the re-presentment stage, or the arbitration stage, and transaction date and time. The chargeback data is stored in tables in the data warehouse. The data warehouse may further include clearing data and transaction data generated as part of transactions conducted over a payment network, including data relating to merchants, account holders or customers, and purchases.

When a new chargeback request is received, the CP computing device, in communication with the payment card processing network, receives chargeback data associated with the new chargeback request and account profile data for a primary account number associated with the new chargeback request. For example, the account profile information may include one or more of the total number of previous chargebacks on the account, previous chargeback amounts, recurring transactions, transaction count by merchant category, transaction amounts by merchant category, whether the payment card was present during the previous chargebacks, transaction decline count, transaction decline amount, user residential spending area, fraud chargeback count, and the like.

The CP computing device further retrieves a plurality of chargeback data stored in the data warehouse to generate the chargeback prediction model. By analyzing historical chargebacks that reached one or more stages, the CP computing device determines whether a chargeback request is likely to reach the presentment stage, the re-presentment stage, or the arbitration stage. The CP computing device uses statistical methods, such as clustering and logistic regression, to analyze the plurality of chargeback data to identify particular data (i.e., indicators) that have historically contributed to a chargeback request reaching a presentment stage, a re-presentment stage, or an arbitration stage. Using the indicators from the chargeback data, the CP computing device generates the chargeback prediction model. The chargeback prediction model is a table containing the indicators that contribute to a chargeback request reaching the presentment stage, the re-presentment stage, or the arbitration stage.

According to various embodiments, the CP computing device uses the chargeback prediction model to analyze the chargeback data associated with the new chargeback request and the account profile information to determine whether the new chargeback request will likely reach the presentment stage, the re-presentment stage, or the arbitration stage. More specifically, the CP computing device searches the chargeback data associated with the new chargeback request and the account profile information for the indicators generated in the chargeback prediction model and, based on a statistical comparison, determines the likely chargeback stage for the chargeback request.

Based on the determination, the CP computing device classifies the new chargeback request into one of three types based on the stage the chargeback request is likely to reach:

Type ‘1’: A chargeback that is presented, but the chargeback does not fit a statistical criteria of a chargeback likely to be re-presented or to reach arbitration.

Type ‘2’: A chargeback that is presented and resembles a chargeback that is likely to be re-presented, but does not fit the statistical criteria of a chargeback that normally reaches arbitration.

Type ‘3’: A chargeback that meets the statistical criteria such that it is likely to be re-presented and reach arbitration.

In the example embodiment, the chargeback prediction model is built, and a probability that a chargeback dispute will reach the presentment stage, the re-presentment stage, or the arbitration stage is determined, for each new chargeback.

As an example, a legitimate user of a primary account number may authorize a legitimate transaction with a merchant. However, the CP computing device, using statistical methods, may identify the merchant as having a poor performance record with consumers resulting in uncontested chargebacks. In this example, the primary account number is not a chargeback risk, but rather, the merchant is the risk for often failing to adequately deliver on the transaction. The CP computing device may generate the chargeback prediction model based on the poor merchant prior performance, thus identifying a new chargeback request associated with the merchant as likely ending at a presentment stage.

As another example, a primary account number may be used to make a legitimate transaction at a merchant, but the primary account number may have a significant history of submitting chargeback requests that have reached the re-presentment stage or the arbitration stage. Therefore, the chargeback prediction model may indicate that a new chargeback request is likely to reach the re-presentment stage or the arbitration stage.

In one embodiment, a chargeback type is transmitted to a user on a user computing device. The chargeback type, as defined above, provides the user with the probability or likelihood that a chargeback request will reach the presentment stage, the re-presentment stage or the arbitration stage.

In the exemplary embodiments, the chargeback data stored in the data warehouse is continually updated as new chargeback data is received from the payment card processing network. Accordingly, the chargeback prediction model is continually updated or refreshed based on recently received chargeback data.

In some embodiments, the CP computing device is configured to assist in identifying indicators that have greater weight in predicting a chargeback stage, so that the chargeback prediction model can be improved and made more efficient. For example, in the process of building the chargeback prediction model, the indicators may be analyzed and their contribution toward the accuracy of the chargeback prediction model may be investigated. As a result of the investigation, some indicators may be determined to generate a more accurate prediction of reaching a particular chargeback stage while some indicators may contribute little to the prediction accuracy, or even make the chargeback stage prediction less accurate. In this example, indicators that improve the accuracy of the chargeback prediction model may be identified while negligible indicators that hinder accuracy may be disregarded to improve the efficiency of the chargeback prediction model. Accordingly, improving indicators may be identified and given more weight while negligible indicators may be removed and/or given little or no weight.

The methods and systems described herein may be implemented using computer programming or engineering techniques including computer software, firmware, hardware or any combination or subset thereof, wherein the technical effect may be achieved by performing at least one of the following steps: (a) receiving, at a CP (chargeback prediction) computing system, chargeback data associated with a new chargeback request from a payment network; (b) generating a chargeback prediction model by statistically analyzing a plurality of chargeback data retrieved from a data warehouse; (c) determining whether the chargeback request is likely to reach a presentment stage, a re-presentment stage, or an arbitration stage; (d) classifying the new chargeback request into a chargeback type; and (e) transmitting the chargeback type to a computing device.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to predicting the probability that a chargeback request will reach a presentment stage, a re-presentment stage, or an arbitration stage.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

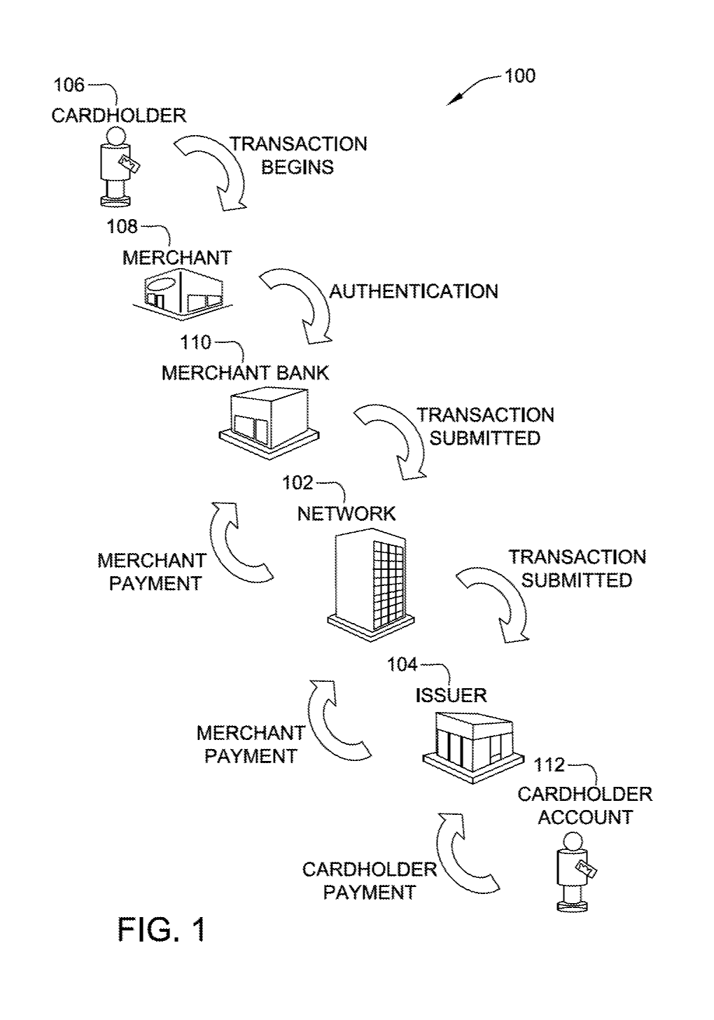

FIG. 1 is a schematic diagram illustrating an exemplary multi-party payment card system 100 for enabling ordinary payment-by-card transactions. The present disclosure relates to payment card system 100, such as a credit card payment network using the MasterCard® payment card system interchange network 102. MasterCard payment card system interchange network 102 is a proprietary communications standard promulgated by MasterCard International Incorporated for the exchange of financial transaction data between financial institutions that are customer of MasterCard International Incorporated. (MasterCard is a registered trademark of MasterCard International Incorporated located in Purchase, N.Y.).

In payment card system 100, a financial institution, such as an issuing bank 104, issues a payment account card, such as a credit card account or a debit card account, to a cardholder 106, who uses the payment account card to tender payment for a purchase from a merchant 108. To accept payment with the payment account card, merchant 108 must normally establish an account with a financial institution that is part of the financial payment network. This financial institution is usually called the “merchant bank” or the “acquiring bank” or simply “acquirer.” When a cardholder 106 tenders payment for a purchase with a payment account card (also known as a financial transaction card), merchant 108 requests authorization from acquiring bank 110 for the amount of the purchase. The request may be performed over the telephone, but is usually performed through the use of a point-of-sale terminal, which reads the cardholder's account information from the magnetic stripe or embedded computer chip on the payment account card and communicates electronically with the transaction processing computers of acquiring bank 110. Alternatively, acquiring bank 110 may authorize a third party to perform transaction processing on its behalf. In this case, the point-of-sale terminal will be configured to communicate with the third party. Such a third party is usually called a “merchant processor” or an “acquiring processor.”

Using payment card system interchange network 102, the computers of acquiring bank 110 or the merchant processor will communicate with the computers of issuing bank b104 to determine whether the cardholder's account is in good standing and whether the purchase is covered by the cardholder's available credit line or account balance. Based on these determinations, the request for authorization will be declined or accepted. If the request is accepted, the transaction is given a bank network reference number, such as the Banknet® Reference Number used by MasterCard International Incorporated, an authorization code, and/or other transaction identifiers that may be used to identify the transaction.

During the authorization process of the payment card system, the clearing process is also taking place. During the clearing process, acquiring bank 110 provides issuing bank 104 with information relating to the sale. No money is exchanged during clearing. Clearing (also referred to as “first presentment”) involves the exchange of data required to identify the cardholder's 106 account such as the account number, expiration date, billing address, amount of the sale, and/or other transaction identifiers that may be used to identify the transaction. Along with this data, financial institutions in the United States also include a bank network reference number, such as the Banknet Reference Number used by MasterCard International Incorporated, which identifies that specific transaction. In foreign countries, financial institutions include a 6-digit authorization code to identify the transaction. These will be discussed in further detail below. When the issuing bank 104 receives this data, it posts the amount of sale as a draw against the cardholder's 106 available credit and prepares to send payment to the acquiring bank 110.

When a request for authorization is accepted, the available credit line or available account balance of cardholder's account 112 is decreased. Normally, a charge is not posted immediately to a cardholder's account 112 because payment networks, such as MasterCard International Incorporated, have promulgated rules that do not allow a merchant to charge, or “capture,” a transaction until goods are shipped or services are delivered. When a merchant 108 ships or delivers the goods or services, merchant 108 captures the transaction by, for example, appropriate data entry procedures on the point-of-sale terminal. If a cardholder 106 cancels a transaction before it is captured, a “void” is generated. If a cardholder 106 returns goods after the transaction has been captured, a “credit” is generated.

After a transaction is captured, the transaction is settled between merchant 108, acquiring bank 110, and issuing bank 104. Settlement refers to the transfer of financial data or funds between the merchant's account, acquiring bank 110, and issuing bank 104 related to the transaction. Usually, transactions are captured and accumulated into a “batch,” which is settled as a group.

In some instances, cardholder 106 disputes the transaction. A dispute may occur for technical reasons, such as insufficient funds, for clerical reasons, such as duplicate billing and/or incorrect amount billed, for quality reasons, such as when a consumer claims to have never received the goods as promised, and/or for fraud reasons where a consumer did not authorize the purchase. A dispute may be either a retrieval request or a chargeback.

A retrieval request may be made when cardholder 106 observes unrecognized charges on a statement. Cardholder 106 initiates a retrieval request to issuing bank 104 to obtain proof or documentation relating to the transaction. Issuing bank 104 requests proof or documentation from acquiring bank 110. Upon receipt, issuing bank 104 provides the documentation to cardholder 106. If cardholder 106 is satisfied with the documentation, no further action is taken. However, if cardholder 106 does not agree with the charge, cardholder 106 may initiate a chargeback of funds.

To initiate a chargeback, cardholder 106 contacts issuing bank 104 and disputes the transaction. Issuing bank 104 submits the chargeback transaction to interchange network 102, which provides clearing and settlement services to its members. Interchange network 102 submits the chargeback to acquiring bank 110. Acquiring bank 110 either resolves the dispute or forwards it to merchant 108. Merchant 108 either accepts the chargeback or re-presents it back to acquiring bank 110. If merchant 108 accepts the chargeback, acquiring bank 110 forwards the response back to interchange network 102. Interchange network 102 then settles the chargeback with issuing bank 104. If merchant 108 re-presents the chargeback, acquiring bank 110 rejects the chargeback requested by issuing bank 104, which is a stage referred to as second presentment. Acquiring bank 110 may provide additional proof or documentation that the transaction was valid. Based on the second presentment, issuing bank 104 either accepts it and takes no further action, or rejects the second presentment, which is a stage referred to as arbitration chargeback. Once arbitration chargeback occurs, neither issuing bank 104 nor acquiring bank 110 may initiate any additional chargebacks or presentments. At this point a case filing is automatically generated with interchange network 102, which issues a financial liability decision regarding the chargeback.

Financial transaction cards or payment account cards can refer to credit cards, debit cards, and prepaid cards. These cards can all be used as a method of payment for performing a transaction. As described herein, the term “financial transaction card” or “payment account card” includes cards such as credit cards, debit cards, and prepaid cards, but also includes any other devices that may hold payment account information, such as mobile phones, digital wallets, personal digital assistants (PDAs), and key fobs.

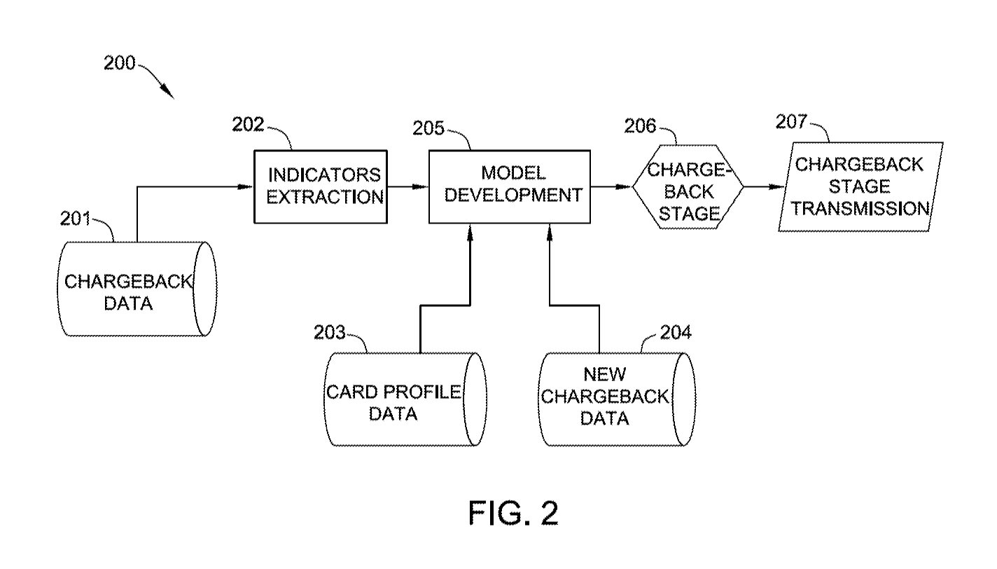

FIG. 2 is a data flow diagram illustrating an example of a chargeback prediction model being generated and used to estimate whether a chargeback request will reach a presentment stage, a re-presentment stage, or an arbitration stage, according to an example embodiment.

Referring to FIG. 2, in 201 the CP (chargeback prediction) computing device is transmitted or retrieves chargeback data from a data warehouse. The chargeback data may include, for example, historical chargeback information. In 202, indicators are identified and extracted from the chargeback data by the CP computing device. For example, the CP computing device may include an indicator extraction module, as illustrated below. The indicator extraction module may perform the indicator extraction 202 from the chargeback data 201. For example, one or more indicators from the chargeback data 201 may include merchant country, merchant state, merchant city, merchant location ID, transaction amount, transaction currency, acquiring bank, acquiring country, issuing bank, issuing country, payment card product type, merchant category code, e-commerce indicator, contactless payment indicator, recurring transaction indicator, user presence indicator, cross border indicator, transaction date and time, number of chargebacks, chargeback stage reached, and the like, which may be extracted by the indicator extraction module.

In 203, the CP computing device transmits or retrieves account profile data from a network. For example, the account profile data may include prior chargeback historical data of a primary account number, one or more of the total number of previous chargebacks of the primary account number, previous chargeback count, previous chargeback amount, previous chargeback stage reached, transaction count by merchant category, transaction amount by merchant category, whether the payment card was present during transaction, transaction decline count, transaction decline amount, user residential spending area, user travel count, fraud chargeback count, and the like. In 204, the CP computing device transmits or retrieves chargeback data associated with a new chargeback request from the payment card processing network.

According to embodiments, the CP computing device may include the chargeback stage prediction module. Based on at least the chargeback data stored in the data warehouse, the chargeback stage prediction module generates the chargeback prediction model in 205 based on statistical methods, such as clustering and logistic regression. The CP computing device then searches the chargeback data associated with the new chargeback request and the account profile information for indicators generated in the chargeback prediction model to determine the likely chargeback stage for the chargeback request. A chargeback type is generated in 206 based on the likely chargeback stage for the chargeback request. The chargeback type generated in 206 is used to indicate the probability that the chargeback request will reach a presentment stage, a re-presentment stage, or an arbitration stage.

The chargeback type for the chargeback request is transmitted in 207 to at least one of the payment processor, the issuing bank, the acquiring bank, a computing device, and the like. In this later case, the chargeback type may be used to predict how many potential chargeback transactions of an issuing bank, or other entity, will reach a presentment stage, a re-presentment stage, or an arbitration stage, thus, giving the bank an idea of an amount of funds that might be necessary to cover the possible chargebacks.

In some examples, subsequent chargeback data information may be used to update the chargeback prediction model in 205. For example, the chargeback prediction model may be updated daily, weekly, bi-weekly, monthly, and the like, with chargeback data generated during that time period.

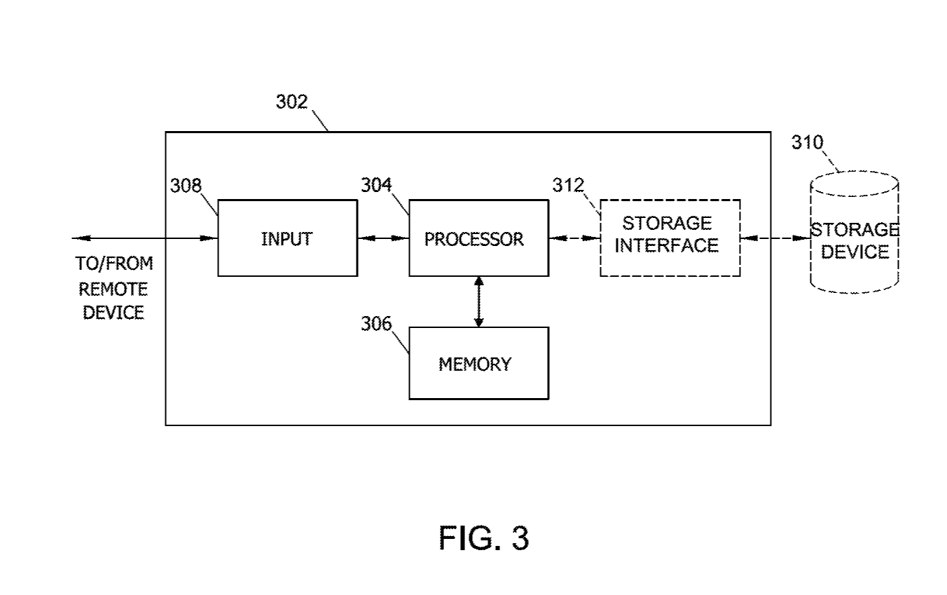

FIG. 3 illustrates an example configuration of a CP (chargeback prediction) computing device as shown in FIG. 2. CP computing device 302 includes a processor 304 for executing instructions. Instructions may be stored in a memory area 306, for example. Processor 304 may include one or more processing units (e.g., in a multi-core configuration).

Processor 304 is operatively coupled to a communication input interface 308, such that CP computing device 302 is capable of communicating with a remote device such as warehouse, computer device or another server computer device. For example, communication interface 308 may transmit a chargeback type to a client system and/or client device via a network.

Processor 304 may also be operatively coupled to a storage device 310. Storage device 310 is any computer-operated hardware suitable for storing and/or retrieving data. In some embodiments, storage device 310 is integrated in CP computing device 302. For example, CP computing device 302 may include one or more hard disk drives as storage device 310. In other embodiments, storage device 310 is external to CP computing device 302 and may be accessed by a plurality of server computer devices. For example, storage device 310 may include multiple storage units such as hard disks or solid state disks in a redundant array of inexpensive disks (RAID) configuration. Storage device 310 may include a storage area network (SAN) and/or a network attached storage (NAS) system.

In some embodiments, processor 304 is operatively coupled to storage device 310 via a storage interface 312. Storage interface 312 is any component capable of providing processor 304 with access to storage device 310. Storage interface 312 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 310.

Memory area 306 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

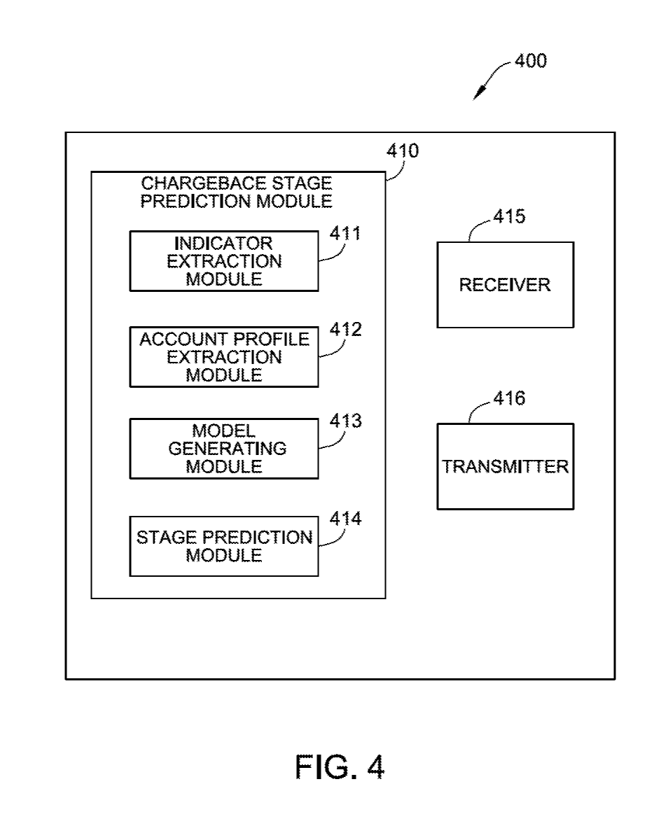

FIG. 4 is a block diagram depicting an example of a CP (chargeback prediction) computing device 400 that is shown in FIG. 3. CP computing device 400 includes a chargeback stage prediction module 410. Based on chargeback data and/or account profile data, chargeback stage prediction module 410 generates a chargeback prediction model and determines a chargeback type for a chargeback request. The predicted chargeback type may be used to indicate the probability that a chargeback request will result in a presentment, a re-presentment or arbitration in the future and ultimately cause an additional use of resources and time by banks and payment processors.

According to one or more examples, chargeback stage prediction module 410 may perform indicator extraction from chargeback data stored in the data warehouse. Chargeback stage prediction module 410 may also be used to generate the chargeback prediction model based on the extracted indicators. Chargeback stage prediction module 410 may include one or more processing devices. Also, chargeback stage prediction module 410 may include a single core processor, a multicore processor, and the like. Chargeback stage prediction module 410 may also include or be in communication with a memory device. For example, data stored in the memory device may be processed by the processor of chargeback stage prediction module 410.

In some examples, chargeback stage prediction module 410 may include a plurality of modules. For example, chargeback stage prediction module 410 may include an indicator extraction module 411, an account profile extraction module 412, a model generating module 413, a chargeback stage prediction module 414, and the like. Indicator extraction module 411 may extract indicators from chargeback data. Account profile extraction module 412 may extract indicators from account data associated with the chargeback request, such as, but not limited to, a chargeback history associated with the account. Model generating module 413 may generate the chargeback prediction model, and the chargeback stage prediction module 414 may be used to determine the probability that a new chargeback request will reach a presentment stage, a re-presentment stage, or an arbitration stage. In this example, any of the indicator extraction module 411, account profile extraction module 412, model generating module 413, and the stage prediction module 414 may be controlled by or replaced by a processing device.

CP computing device 400 may include a receiver 415 that receives a new chargeback request, chargeback data, and account profile data from a network. Also, CP computing device 400 may include a transmitter 416 that may transmit the chargeback type generated by the stage prediction module 414 to another computing device, for example, a device corresponding to a payment processor, an issuing bank (i.e., of the account) or the acquiring bank (i.e., of the merchant).

In some embodiments, the chargeback prediction model may be continually updated or refreshed based on subsequent chargebacks. For example, in addition to generating a chargeback type for a chargeback, the information from the chargeback may also be used to update the chargeback prediction model. Accordingly, the chargeback prediction model may be dynamically updated and refreshed based on the most recent information and chargeback information of a primary account number associated with an account. For example, the chargeback prediction model may be updated or refreshed every week, bi-week, month, and the like.

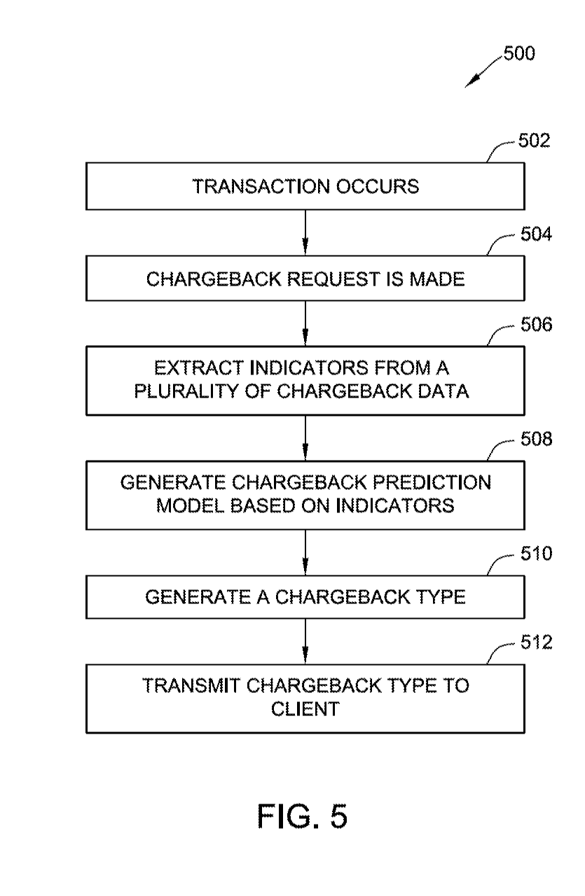

FIG. 5 is a data flow block diagram illustrating an example of a chargeback prediction model and chargeback type generated by a computing device in accordance with an example embodiment of the present disclosure. In 502, an account having a primary account number (PAN) and a payment card associated therewith is used to authorize a payment transaction for goods or services from a merchant. The authorization information may include, for example, an initial payment amount, a merchant identification (ID), a location of the merchant, and whether the payment card is present. The authorization information may be stored in the data warehouse accessible to the CP computing device.

When submitting a payment from an account associated with a payment card, the account payment transactions are authorized almost instantly so funds will be instantly pending for a transaction. However, it may take one to three business days, or more, for the transaction to clear the accountholder's bank or credit account, a process otherwise referred to as clearing. Clearing data generated during the process include one or more of a merchant country, merchant state, merchant city, merchant location ID, transaction amount, transaction currency, acquiring bank, acquiring country, issuing bank, issuing country, card product type, merchant category code, e-commerce indicator, contactless payment indicator, recurring transaction indicator, user presence indicator, cross border indicator, transaction date and time, and the like. The clearing information may be stored in the data warehouse accessible to the CP computing device.

At this point, a user of the primary account number has a period of time during which they may dispute the transaction and request a chargeback of the funds. As an example, the user may have 180 days from the date of the transaction to request a chargeback. When the user requests a chargeback in 504, a chargeback with the issuing bank is initiated. Each time a transaction is charged back, for example, the payment processor of the transaction receives a record that explains why the transaction was charged back as well as other features about the transaction, which is stored in the data warehouse. As the chargeback progresses from a presentment stage to a re-presentment stage and/or an arbitration stage, chargeback data is generated and stored in a data warehouse. This data is retrieved from, or transmitted to, the CP computing device described herein according to various example embodiments.

In 506, upon receiving a new chargeback request, the CP computing device extracts indicators from the chargeback data stored in the data warehouse. An indicator extraction module may perform the indicator extraction from the chargeback data. In 508, the method generates a chargeback prediction model based on the indicators. According to various examples, the CP computing device may include the chargeback stage prediction module that generates the chargeback prediction model. The CP computing device then searches account profile data and chargeback data associated with the new chargeback request for the indicators identified in the chargeback prediction model.

A chargeback type for the chargeback request is generated in 510 based on the chargeback prediction model, and transmitted in 512 to a client, which may be at least one of the payment processor, the issuing bank, the acquiring bank, and the like. In this later case, the chargeback type may be used to predict how many potential chargeback requests of an issuing bank, or other entity, will progress to an advanced stage, thus, giving the bank an idea of an amount of money that might be necessary to cover the possible chargebacks.

As will be appreciated based on the foregoing specification, the above-described examples of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed examples of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

For example, one or more computer-readable storage media may include computer-executable instructions embodied thereon for determining the probability of an authorized transaction resulting in a chargeback. In this example, the computing device may include a memory device and a processor in communication with the memory device, and when executed by said processor the computer-executable instructions may cause the processor to perform a method such as the method described and illustrated in the example of FIG. 5.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

This written description uses examples to disclose the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for predicting a chargeback stage for a payment transaction, the method implemented by a chargeback prediction computing device in communication with a memory, said method comprising:
receiving chargeback data from a plurality of chargebacks associated with a plurality of account holders, wherein the chargeback data includes a plurality of variables;
determining a set of indicators from the plurality of variables, wherein the indicators are variables associated with each chargeback stage;
generating a chargeback prediction model based on the set of indicators;
receiving candidate chargeback data for a candidate chargeback request, wherein the candidate chargeback data includes a plurality of candidate variables;
applying the chargeback prediction model to the candidate chargeback data to generate an output; and
generating a chargeback type for the candidate chargeback request based on the output from the chargeback prediction model and the candidate chargeback data, wherein the chargeback type indicates a probability that the candidate chargeback request will reach a particular chargeback stage.

2. The method of claim 1, wherein applying the chargeback prediction model further comprises identifying one or more indicators from the plurality of candidate variables, wherein the one or more indicators are included within the set of indicators, and provide an indication as to which chargeback stage the candidate chargeback request will likely reach.

3. The method of claim 1, wherein the chargeback stages include a presentment stage, a re-presentment stage, and an arbitration stage.

4. The method of claim 3, wherein the chargeback types include (i) a first chargeback type representing a candidate chargeback request reaching the presentment stage but not the re-presentment stage or the arbitration stage of the chargeback process, (ii) a second chargeback type representing a candidate chargeback request reaching the re-presentment stage but not the arbitration stage of the chargeback process, and (iii) a third chargeback type representing a candidate chargeback request reaching the arbitration stage of the chargeback process.

5. The method of claim 1, further comprising transmitting a data signal to a user computing device, causing the chargeback type to be displayed on the user computing device, the user device being associated with an issuer bank, the issuer bank having initiated the candidate chargeback request.

6. The method of claim 1, further comprising updating the chargeback prediction model based on an actual chargeback stage reached by the candidate chargeback request as compared to the chargeback type predicted for the candidate chargeback request.

7. The method of claim 1, wherein the chargeback data for the candidate chargeback request includes account profile data for a primary account number associated with the candidate chargeback request.

8. The method of claim 1, further comprising using statistical modeling to determine the set of indicators associated with each chargeback of the plurality of chargebacks, the statistical modeling including clustering and logistic regression for identifying the set of indicators that have historically contributed to a chargeback request reaching one of a presentment stage, a re-presentment stage, and an arbitration stage.

9. A chargeback prediction computing device for predicting a chargeback stage for a payment transaction, said chargeback prediction computing device in communication with a memory and configured to:
store, within the memory, chargeback data from a plurality of chargebacks associated with a plurality of account holders, wherein the chargeback data includes a plurality of variables;
determine a set of indicators from the plurality of variables, wherein the indicators include variables associated with each chargeback stage;
generate a chargeback prediction model based on the set of indicators;
receive candidate chargeback data for a candidate chargeback request, wherein the candidate chargeback data includes a plurality of candidate variables;
apply the chargeback prediction model to the candidate chargeback data to generate an output; and
generate a chargeback type for the candidate chargeback request based on the output from the chargeback prediction model and the candidate chargeback data, wherein the chargeback type indicates a probability that the candidate chargeback request will reach a particular chargeback stage.

10. The chargeback prediction computing device of claim 9 further configured to: identify one or more indicators from the plurality of candidate variables by applying the chargeback prediction model, wherein the one or more indicators are included within the set of indicators and provide an indication as to which chargeback stage the candidate chargeback request will likely reach.

11. The chargeback prediction computing device of claim 9 wherein the chargeback stages include a presentment stage, a re-presentment stage, and an arbitration stage.

12. The chargeback prediction computing device of claim 11 wherein the chargeback types include (i) a first chargeback type representing a candidate chargeback request reaching the presentment stage but not the re-presentment stage or the arbitration stage of the chargeback process, (ii) a second chargeback type representing a candidate chargeback request reaching the re-presentment stage but not the arbitration stage of the chargeback process, and (iii) a third chargeback type representing a candidate chargeback request reaching the arbitration stage of the chargeback process.

13. The chargeback prediction computing device of claim 9 further configured to transmit a data signal to a user computing device, causing the chargeback type to be displayed on the user computing device, the user computing device being associated with an issuer bank, the issuer bank having initiated the candidate chargeback request.

14. The chargeback prediction computing device of claim 9 further configured to update the chargeback prediction model based on an actual chargeback stage reached by the candidate chargeback request as compared to the chargeback type predicted for the candidate chargeback request.

15. The chargeback prediction computing device of claim 9 wherein the chargeback data for the candidate chargeback request includes account profile data for a primary account number associated with the candidate chargeback request.

16. The chargeback prediction computing device of claim 9 further configured to use statistical modeling to determine the set of indicators associated with each chargeback of the plurality of chargebacks, the statistical modeling including clustering and logistic regression for identifying the set of indicators that have historically contributed to a chargeback request reaching one of a presentment stage, a re-presentment stage, and an arbitration stage.

17. A non-transitory computer-readable storage medium having computer-executable instructions embodied thereon, wherein when executed by a chargeback prediction computing device having at least one processor coupled to a memory, the computer-executable instructions cause the chargeback prediction computing device to:
store, within the memory, chargeback data from a plurality of chargebacks associated with a plurality of account holders, wherein the chargeback data includes a plurality of variables;
determine a set of indicators from the plurality of variables, wherein the indicators include variables associated with each chargeback stage;
generate a chargeback prediction model based at least in part on the set of indicators;
receive candidate chargeback data for a candidate chargeback request, wherein the candidate chargeback data includes a plurality of candidate variables;
apply the chargeback prediction model to the candidate chargeback data to generate an output; and
generate a chargeback type for the candidate chargeback request based on the output from the chargeback prediction model and the candidate chargeback data, wherein the chargeback type indicates a probability that the candidate chargeback request will reach a particular chargeback stage.

18. The non-transitory computer-readable storage medium of claim 17, wherein the computer-executable instructions further cause the chargeback prediction computing device to identify one or more indicators from the plurality of candidate variables by applying the chargeback prediction model, wherein the one or more indicators are included within the set of indicators and provide an indication as to which chargeback stage the candidate chargeback request will likely reach.

19. The non-transitory computer-readable storage medium of claim 17, wherein the computer-executable instructions further cause the chargeback prediction computing device to transmit a data signal to a user computing device, causing the chargeback type to be displayed on the user computing device, the user computing device being associated with an issuer bank, the issuer bank having initiated the candidate chargeback request.

20. The non-transitory computer-readable storage medium of claim 17, wherein the computer-executable instructions further cause the chargeback prediction computing device to:
use statistical modeling to determine the set of indicators associated with each chargeback of the plurality of chargebacks, the statistical modeling including clustering and logistic regression for identifying the set of indicators that have historically contributed to a chargeback request reaching one of a presentment stage, a re-presentment stage, and an arbitration stage; and
update the chargeback prediction model based on an actual chargeback stage reached by the candidate chargeback request as compared to the chargeback type predicted for the candidate chargeback request.
